(19) United States
(12) Patent Application Publication
(10) Pub. No.: US 2014/0156051 A1
(43) Pub. Date: Jun. 5, 2014

(54) QUALITY CONTROL OF AN OBJECT DURING MACHINING THEREOF

(71) Applicant: LABORATOIRES BODYCAD INC., Quebec (CA)

(72) Inventor: Florent MIQUEL, Quebec (CA)

(73) Assignee: LABORATOIRES BODYCAD INC., Quebec (CA)

(21) Appl. No.: 14/097,616

(22) Filed: Dec. 5, 2013

Related U.S. Application Data
(60) Provisional application No. 61/733,489, filed on Dec. 5, 2012.

(51) Int. Cl. G05B 19/418

(52) U.S. Cl. CPC G05B 19/41875
USPC 700/110

(57) ABSTRACT

A system and method for controlling the quality of an object during machining thereof with a machine. Measurement data is received from a measuring device during the machining, the measurement data comprising at least one measurement of the object. It is determined from the received measurement data whether the object comprises a defect. An output signal is then generated to cause the machine to correct a detected defect.

### CROSS-REFERENCE TO RELATED APPLICATIONS

This patent application claims priority of U.S. provisional Application Ser. No. 61/733,489, filed on Dec. 5, 2012, the contents of which are hereby incorporated by reference.

### TECHNICAL FIELD

The present invention relates to the field of quality control of an object during machining thereof.

### BACKGROUND OF THE ART

When manufacturing objects, it may be desirable to control the quality thereof prior to completing the manufacturing process and shipping the objects to destination. For example, when manufacturing complex geometry objects, such as prostheses, it is desirable for the prostheses to be adapted to fit each patient's unique anatomical features, thus increasing the outcome of the surgical procedure. However, despite careful pre-operative planning, prosthetic components may comprise defects once manufactured. Such defects may further remain undetected and uncorrected and when the components are implanted in a patient's body, they may turn out to be in a less than optimal biomechanical position relative to the patient's anatomy. As a result, pain may be caused to the patient and premature wear or even failure of the prosthetic components may occur.

There is therefore a need for an improved system for controlling the quality of an object during manufacturing thereof.

### SUMMARY

There is described a system and method for controlling the quality of an object during machining thereof on a machine. A measuring device is coupled to the object for acquiring measurements of at least one exposed surface of the object. The measurements may be used to determine whether defects are present on the at least one exposed surface. If this is the case, an output signal may be sent to the machine for instructing the latter to perform corrective actions to remove the defect. Otherwise, instructions may be sent to at least one of the machine and the measuring device so that the object may be placed in a different position relative to the measuring device for acquiring new measurements.

In accordance with a first broad aspect, there is provided a system for controlling a quality of an object during machining thereof with a machine, the system comprising a memory; a processor; and at least one application stored in the memory and executable by the processor for receiving during the machining measurement data from a measuring device, the measurement data comprising at least one measurement of the object, determining from the received measurement data whether the object comprises a defect, and generating a first output signal for causing the machine to correct a detected defect.

In accordance with a second broad aspect, there is provided a computer-implemented method for controlling a quality of an object during machining thereof with a machine, the method comprising receiving during the machining measurement data from a measuring device, the measurement data comprising at least one measurement of the object; determining from the received measurement data whether the object comprises a defect; and generating a first output signal for causing the machine to correct a detected defect.

In accordance with a third broad aspect, there is provided a computer readable medium having stored thereon program code executable by a processor for controlling a quality of an object during machining thereof with a machine, the program code executable for receiving during the machining measurement data from a measuring device, the measurement data comprising at least one measurement of the object; determining from the received measurement data whether the object comprises a defect; and generating a first output signal for causing the machine to correct a detected defect.

### BRIEF DESCRIPTION OF THE DRAWINGS

Further features and advantages of the present invention will become apparent from the following detailed description, taken in combination with the appended drawings, in which:

FIG. 1a is a flowchart of a computer-aided method for controlling the quality of an object during manufacturing thereof in accordance with an illustrative embodiment of the present invention;

FIG. 1b is a flowchart of the step of FIG. 1a of determining whether defects have been detected;

FIG. 2a is a schematic diagram of a system for controlling the quality of an object during manufacturing thereof in accordance with an illustrative embodiment of the present invention;

FIG. 2b is a schematic diagram of the quality control system of FIG. 2a communicating with a plurality of user devices;

FIG. 2c is a schematic diagram of an application running on the processor of FIG. 2b;

FIG. 3a is a schematic diagram of a milling machine used with the system of FIG. 2a;

FIG. 3b is a schematic diagram showing the support member of FIG. 3a rotated counterclockwise by ninety (90) degrees to expose the first side surface of the prosthesis to the measuring device;

FIG. 3c is a schematic diagram showing the support frame of FIG. 3b rotated clockwise by forty-five (45) degrees to expose the top surface of the prosthesis to the measuring device;

FIG. 3d is a schematic diagram showing the support frame of FIG. 3b rotated clockwise by ninety (90) degrees;

FIG. 3e is a schematic diagram showing the support member of FIG. 3d rotated counterclockwise by ninety (90) degrees;

FIG. 3f is a schematic diagram showing the support frame of FIG. 3e rotated counterclockwise to expose the second side surface of the prosthesis to the measuring device;

FIG. 3g is a schematic diagram showing the support member of FIG. 3f rotated clockwise by ninety (90) degrees to expose the front surface of the prosthesis to the measuring device;

FIG. 4a is a schematic diagram of a polishing machine used with the system of FIG. 2a;

FIG. 4b is a schematic diagram showing the rear surface of the prosthesis of FIG. 4a exposed to the measuring device; and

FIG. 4c is a schematic diagram showing the upper surface of the prosthesis of FIG. 4a exposed to the measuring device.

It will be noted that throughout the appended drawings, like features are identified by like reference numerals.

### DETAILED DESCRIPTION

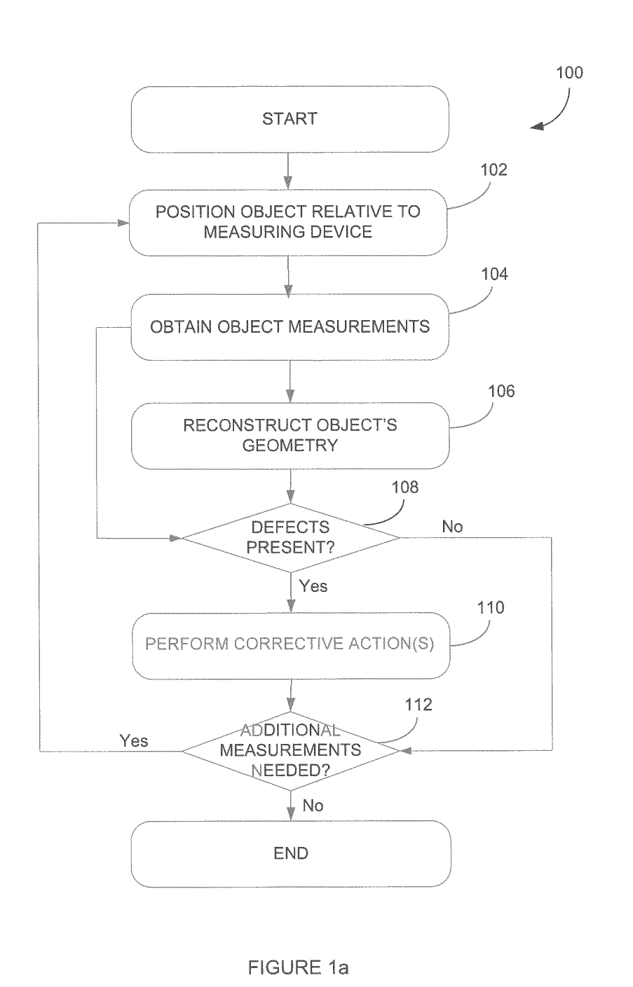

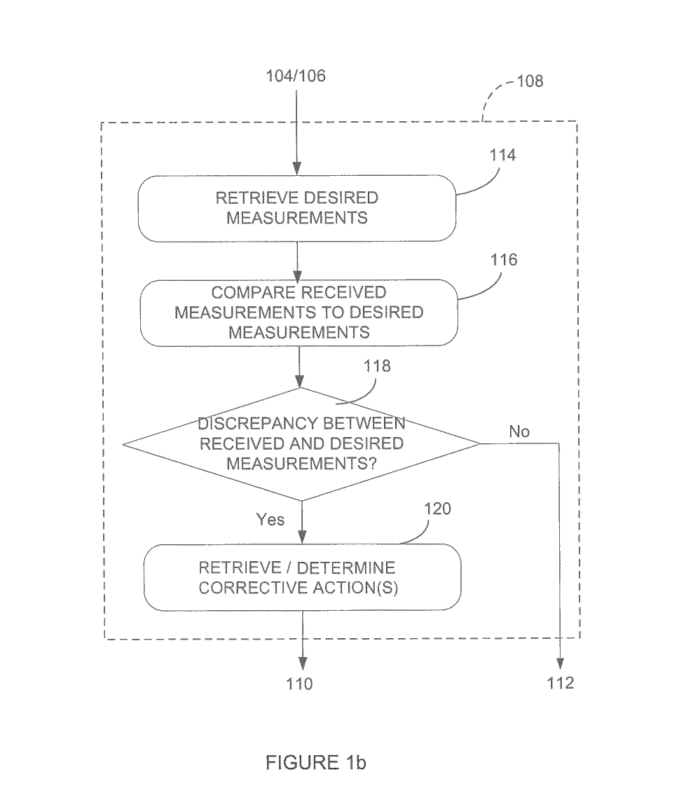

Referring to FIG. 1a, a computer-aided method 100 for controlling the quality of an object during manufacturing thereof will now be described. Such manufacturing may relate to a variety of industrial processes, such as machining processes used for cutting raw material into a desired final shape and size for creating the object, as well as finishing processes, such as polishing, used to improve and control the appearance, resistance, surface friction, and the like, of the machined object. It should be understood that other suitable processes known to those skilled in the art may also apply. For instance, the manufacturing process may include, but is not limited to, milling, casting (including casting using rapid prototyped patterns), welding, forging, and the like, and that various machines may be used to perform these processes. Moreover, although the description below relates to a patient-specific prosthetic implant, it should be understood that other objects, whether of complex geometry or not, may apply.

A measuring device, such as a laser scanner, may be used to acquire measurements of the object's geometry. The method 100 thus comprises at step 102 positioning the object (which is illustratively partially manufactured) relative to the measuring device and at step 104 obtaining object measurements from the measuring device during machining of the object. For example, an exposed surface of the object may be positioned adjacent the measuring device at step 102 and such an exposed surface may then be scanned by the measuring device to acquire precise measurements of the surface at step 104 (e.g. while object is being machined). The obtained measurements include, but are not limited to, dimensional measurements, such as a thickness, height, length, diameter, width, curvature, slope in one or more locations and/or directions, angle (e.g. resection cut angle), and the like, of the object, as well as measurements related to specific features, e.g. asperities or ripples, of at least one surface of the object. The object's geometry (e.g. the surface geometry) may further be optionally reconstructed at step 106 from the measurements acquired by the measuring device.

The method 100 may then determine at step 108 whether one or more defects are present on the object on the basis of the received measurements and/or the reconstructed geometry. For example, a defect may be detected if, for a given point on a surface of the object, the thickness measured by the measuring device is greater than a thickness to be achieved when manufacturing the object. If at least one defect has been detected, the method 100 may flow to the step 110 of performing in real-time corrective action(s) to remove the defect(s). Such corrective action(s) may comprise removing material from the object's surface at the point on the object's surface where the measured thickness has been found to be greater than the desired thickness. In one embodiment, machining of the object is performed sequentially by object surface or area. Once a defect is detected (e.g. for a given manufactured object surface), the machining process is then be interrupted to perform the corrective action(s) and may only resume once the corrective action(s) have been completed. In this manner, manufacturing of the object can be controlled as the machining process advances.

Once the corrective actions have been performed, the method 100 may then determine at step 112 whether additional measurements are needed. New measurements may also be needed if it is determined that the measurements that have already been acquired are not accurate. New measurements may for example be needed if measurements of all surfaces of the object have not already been acquired by the measuring device. Additional measurements may also be needed if the machining process is not complete (e.g. more material to be removed from a raw workpiece the object is being manufactured from) in order to arrive the final shape of the object. In the latter case, a given object area for which measurements are to be acquired may not be machined at the time the initial object measurements have been taken (at step 104). Once the machining process will have advanced sufficiently such that the object area in question has been fully machined, additional measurements may then be obtained for the object area.

If no additional measurements are needed, the method 100 ends. Otherwise, the method 100 may flow back to the step 102 of positioning the object relative to the measuring device. The quality control process steps described above may then be repeated. If it is determined at step 108 that no defects are present on the object, the method 100 may flow directly to the step 112 of assessing whether additional measurements are needed.

It should be understood that the step 112 of determining whether additional measurements are needed may be performed prior to determining at step 108 if defects are present and prior to performing corrective actions at step 110. Indeed, the method 100 may allow for all necessary object measurements to be obtained prior to any processing being performed on the acquired data to detect defects. In this manner, quality control may be performed once subsequently to having acquired the needed measurements, e.g. measurements of all surfaces of the object, rather than periodically each time a new measurement, e.g. a measurement of a given surface, is obtained.

Referring to FIG. 1b, the step 108 of assessing whether defects are present on the object illustratively comprises retrieving desired measurements at step 114. These desired measurements may be predetermined and indicative of the geometry to be achieved in the object once manufacturing has been completed. The measurements obtained from the measuring device at step 104 may then be compared to the desired measurements at step 116. It may then be determined at step 118 whether a discrepancy exists between the received measurements and the desired measurements. This may, for example, be done by computing a difference between the received measurements and the desired measurements and detecting a discrepancy if the difference is not equal to zero or to a predetermined acceptable tolerance or threshold. If no discrepancy is detected, the method 100 then flows to the step 112 of assessing whether additional measurements are needed. Otherwise, at step 120, corrective actions that should be taken to remove the defect may be retrieved (e.g. from a memory) or determined (e.g. calculated) in accordance with the detected defect, as will be discussed further below. The method 100 may then flow to the step 110 of performing the corrective actions in real-time.

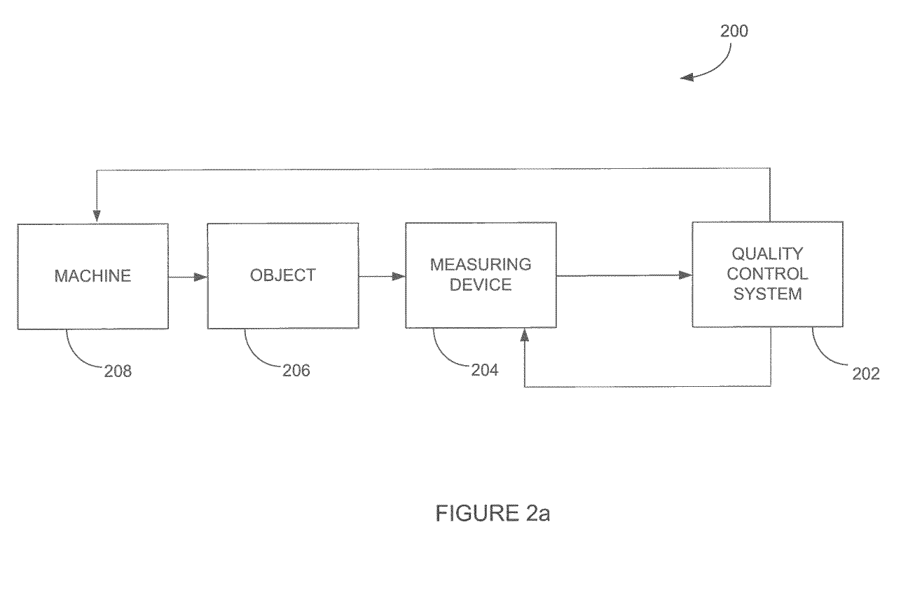

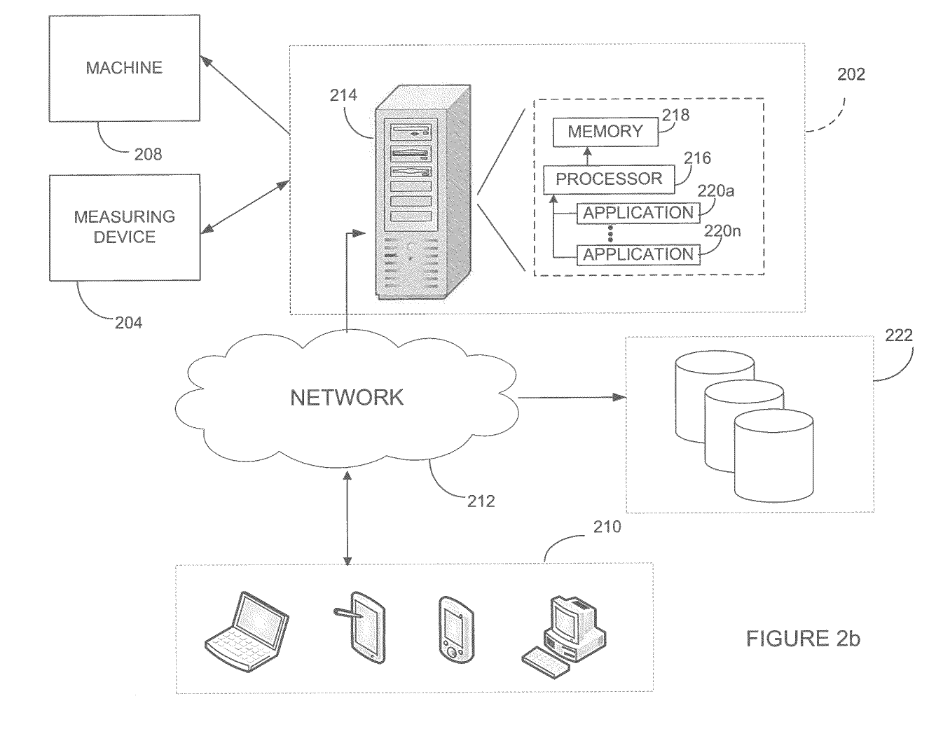

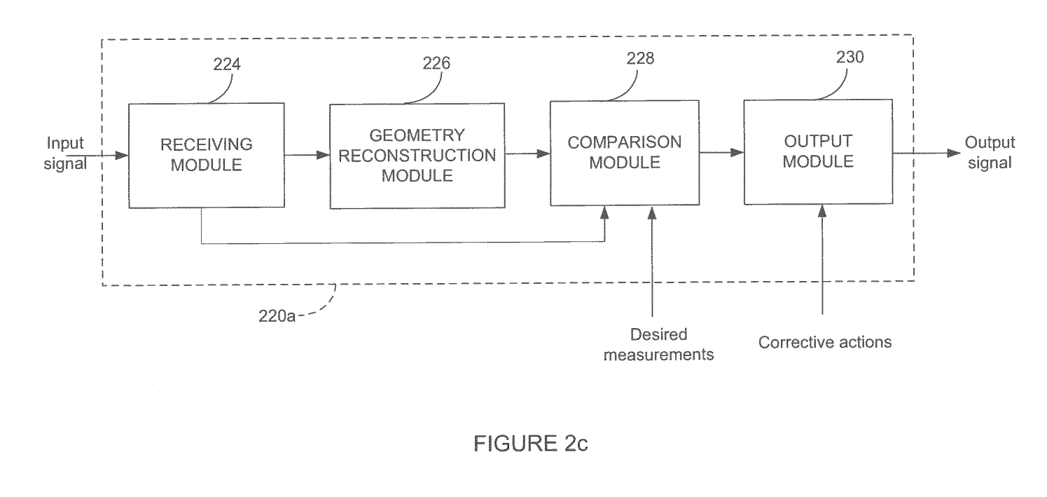

Referring now to FIG. 2a, a system 200 for controlling the quality of an object during manufacturing thereof will now be described. The system 200 illustratively comprises a quality control system 202, which is adapted to receive measurements from a measuring device 204. The measuring device 204 acquires precise measurements of the object 206 for the purpose of determining a geometry thereof during manufacturing on a machine 208. The machine 208 may be any suitable machine used for manufacturing the object 206, such as a milling machine, a polishing machine, or the like. The measuring device 204 may comprise, but is not limited to, a laser scanner, a time-of-flight scanner, a line scanner, a structured-light scanner, and a mechanical scanning device.

The measuring device 204 may be adapted to acquire dimensional measurements, e.g. measure a height, length, thickness, diameter, etc, of the entire object 206. The measuring device 204 may also be adapted to acquire measurements of specific features of the object 206. This may be desirable when the object 206 is a free-form object 206 having no fixed dimensions and characterized by an asymmetrical shape or outline (in which case free-form manufacturing processes may be used to produce the object 206). Such features may comprise asperities, ripples, or depressions formed to create macro, micro, or nano-sized topologies on the surface of the object 206. For this purpose, the measuring device 204 may continuously scan the surfaces of the object 206 and output three-dimensional (3D) images of such scanned surfaces. It should be understood that, in some embodiments, two-dimensional (2D) images may also be output by the measuring device 204 upon scanning the object surfaces. Alternatively, the measuring device 204 may intermittently acquire measurements at various points on the object's surface and send these point-to-point measurements to the quality control system 202 so the latter may reconstruct the surface from the received measurements.

Upon receiving the measurements from the measuring device 204, the quality control system 202 illustratively generates a first output signal, which may be sent to the machine 208 for controlling an operation thereof in real-time, as will be discussed further below. The quality control system 202 may also generate a second output signal that is sent to the measuring device 204 for controlling an operation thereof in real-time. In this manner, the manufacturing process may be controlled in real-time in a closed-loop fashion.

Referring to FIG. 2b, the quality control system 202 may communicate with a plurality of devices 210 via a network 212, such as the Internet, a cellular network, or others known to those skilled in the art. For instance, quality control data may be transmitted over the network 212 to the devices 210 and presented on an interface thereof, e.g. a screen. The devices 210 may further enable users, such as technicians and other operators, to access the quality control system 202. The devices 210 may comprise any device, such as a computer, e.g. a laptop or a desktop computer, a personal digital assistant (PDA), a smartphone, or the like, adapted to communicate over the network 212. Although not illustrated, it should be understood that the quality control system 202 may communicate with the measuring device 204 and/or the machine 208 via the network 212.

The quality control system 202 may further comprise one or more server(s) 214. For example, a series of servers corresponding to a web server, an application server, and a database server may be used. These servers are all represented by server 214 in FIG. 2b. The server 214 may comprise, amongst other things, a processor 216 coupled to a memory 218 and having a plurality of applications 220a, . . . , 220n running thereon. The processor 216 may access the memory 218 to retrieve data. The processor 216 may be any device that can perform operations on data. Examples are a central processing unit (CPU), a microprocessor, and a front-end processor. The applications 220a, . . . , 220n are coupled to the processor 216 and configured to perform various tasks as explained below in more detail. It should be understood that while the applications 220a, . . . , 220n presented herein are illustrated and described as separate entities, they may be combined or separated in a variety of ways.

The memory 218 accessible by the processor 216 may receive and store data. The memory 218 may be a main memory, such as a high speed Random Access Memory (RAM), or an auxiliary storage unit, such as a hard disk or flash memory. The memory 214 may be any other type of memory, such as a Read-Only Memory (ROM), Erasable Programmable Read-Only Memory (EPROM), or optical storage media such as a videodisc and a compact disc.

One or more databases 222 may be integrated directly into the memory 218 or may be provided separately therefrom and remotely from the server 214 (as illustrated). In the case of a remote access to the databases 222, access may occur via any type of network 212, as indicated above. The databases 222 described herein may be provided as collections of data or information organized for rapid search and retrieval by a computer. The databases 222 may be structured to facilitate storage, retrieval, modification, and deletion of data in conjunction with various data-processing operations. The databases 222 may consist of a file or sets of files that can be broken down into records, each of which consists of one or more fields. Database information may be retrieved through queries using keywords and sorting commands, in order to rapidly search, rearrange, group, and select the field. The databases 222 may be any organization of data on a data storage medium, such as one or more servers.

FIG. 2c is an exemplary embodiment of an application 220a running on the processor 216. The application 220a illustratively comprises a receiving module 224, a geometry reconstruction module 226, a comparison module 228, and an output module 230. The receiving module 224 illustratively receives an input signal comprising the measurements acquired by the measuring device 204. As discussed above, such measurements may comprise dimensional measurements, such as measurements of a thickness or length of the object 206, measurements taken at specific points on the surface of the object 206, i.e. point-to-point measurements, or scans of entire surfaces of the object 206. Upon receiving the measurements, the receiving module 224 illustratively discriminates between the received data. If the received data comprises point-to-point measurements, it may be desirable to reconstruct a geometry (e.g. a surface geometry) of the object 206 from the received measurements. In this case, the receiving module 224 may send the received point-to-point measurements to the geometry reconstruction module 226, which may reconstruct from the received data the geometry of the object 206 using suitable image reconstruction techniques known to those skilled in the art. The geometry reconstruction module 226 may then send the reconstructed geometry to the comparison module 228. If the data received at the receiving module 224 comprises surface scans or dimensional measurements from which the geometry of the object 206 need not be reconstructed, the data may be sent directly to the comparison module 228.

Upon receiving data from the geometry reconstruction module 226 (or the receiving module 224), the comparison module 228 may retrieve from the memory 218 and/or databases 222 desired measurements of the object 206. Such desired measurements may comprise data related to a desired geometry (e.g. a desired surface geometry) of the object as well as predetermined threshold measurements, e.g. a maximum thickness or length. The data related to the desired geometry may comprise images (e.g. 2D or 3D) of surfaces of the object 206 showing the geometry to be achieved during manufacturing of the object 206. When dimensional measurements are received at the comparison module 228, the predetermined threshold measurements may be retrieved. The comparison module 228 may then compare the received data to the retrieved threshold measurements in order to determine whether any defects have occurred during manufacturing of the object. The comparison may for instance be done by computing a difference between the received dimensional measurements and the retrieved thresholds. If the measurements are above the thresholds, the comparison module 228 may then identify that defects are present on the object 206. For example, the comparison module 228 may determine that the length of the object 206 is greater than desired.

The comparison may also be done by comparing the scanned or reconstructed surface to the desired surface geometry retrieved from the memory 218 and/or databases 222. If the comparison module 228 identifies discrepancies between the scanned or reconstructed surface and the desired surface geometry, a conclusion as to the presence of defects may be reached. For example, the comparison module 228 may determine, upon comparing the scanned and desired surfaces, that bumps, i.e. excess material, are found at specific points on the scanned surface of the object 206.

As discussed above with reference to FIG. 1a, it should be understood that the comparison module 228 may perform the comparison between the data received from the receiving module 224 and/or the geometry reconstruction module 226 and the desired measurements retrieved from the memory 218 and/or databases 222 once all needed measurements, e.g. measurements of all surfaces of the object, have been obtained. In this case, the comparison module 228 may therefore perform the comparison once for all received object measurements rather than periodically each time a new measurement is received. For this purpose, prior to the comparison module 228 processing and comparing acquired data to detect defects, the system 200 may execute a pre-determined software program to cause a series of object measurements to be obtained for all desired positions of the object 206.

The comparison module 228 may then output a comparison result indicating the nature of the defect, e.g. the measured length of the object 206 is above the threshold or excess material is found at specific points on the surface of the object 206. The result of the comparison performed by the comparison module 228 is then sent to the output module 230, which may generate an output signal according to the comparison result. For example, if the comparison module 228 determines that a defect is present on the object 206, the output module 230 may generate an output signal indicating such a fact and that corrective actions are to be taken in real-time. The output signal may be presented on an interface, e.g. a screen, of the devices 210. The output signal may further comprise instructions as to which corrective actions, i.e. additional manufacturing steps, are to performed to correct the defects.

For this purpose, the memory 218 and/or databases 222 may store therein a list of defects (e.g. defects likely to be found on the object 206) and a corresponding list of corrective actions to be taken to correct such defects. For example, indication may be provided that, when an object as in 206 has a thickness greater than a predetermined threshold, excess material is to be removed from the object 206 by a cutting tool (not shown) provided with the machine 208 or any other suitable removal process. It should be understood that, in some embodiments, the corrective action(s) may alternatively (or in addition) comprise adding material onto the object 206 using any suitable additive process, deforming (i.e. modifying a shape or outline of) the object 206 (e.g. bending an area thereof), or the like. As such, any suitable tool (not shown) provided with the machine 208 including, but not limited to, a grinding tool, one or more brushes, a saw, a reamer, and the like, may be used. The output module 230 may then retrieve from the memory 218 and/or databases 222 the corrective action(s) appropriate for correcting the defect identified on the basis of the comparison result received from the comparison module 228 (the identified defect being among the list of likely defects stored in the memory 218 and/or databases 222). The retrieved corrective action(s) may then be provided in the output signal generated by the output module 230. Such an output signal may be sent in real-time to the machine 208 for causing the latter to perform the corrective action(s) and/or to the devices 210 for rendering thereon.

In some embodiments, rather than corrective action(s) being retrieved from the memory 218 and/or databases 222, the corrective action(s) may be calculated by the comparison module 228 upon the latter detecting a defect. In particular, upon receiving input data from the receiving module 224 and/or the geometry reconstruction module 226 and detecting one or more defects, the comparison module 228 may determine one or more corrective actions specifically for correcting the detected defect(s). For instance, the comparison module 228 may receive the reconstructed geometry from the geometry reconstruction module 226 and determine therefrom that an excessive material thickness is present at a given area of the object (reference 206 in FIG. 2a). The comparison module 228 may then compute a specific machine path tailored to cause removal of the excess material from the given object area. In particular, upon the machine 208 executing the computed machine path, a tool (e.g. a cutting tool) provided with the machine 208 will follow movements specified by the machine path. This will result in progressive removal of the excess material from the object area, thereby correcting the defect.

The comparison module 228 may then transmit the computed corrective action(s) to the output module 230. In one embodiment, such corrective action(s) may be generated as a code (e.g. a Computer Numerical Control (CNC) code) comprising commands that specify the computed machine path. Although not illustrated, it should be understood that computation of the corrective action(s) may be performed in a module (not shown) separate from the comparison module 228. Such a module may receive input data from the comparison module 228 and output data to the output module 230 so the latter may generate the output signal, as discussed above.

The output module 230 may further generate and send an output signal to the machine 208 for causing the corrective action(s) to be performed (e.g. the retrieved correction action(s) to be performed or the calculated machine path to be followed by the tool). In particular, the output signal may be used to send specific instructions to the machine 208 in order to control operation of the latter so as to implement the corrective actions in real-time. For example, and as discussed above, if it is determined that the machine 208 is to remove additional material from a specific area of the object 206, the output signal may include instructions to move the cutting tool coupled to the machine 208 to the desired area. The output signal may further comprise instructions to activate rotation of the cutting tool, thereby performing the desired cutting action to correct the identified defect. As a result, the output signal may cause the manufacturing process to be interrupted while the required corrective steps are performed. Normal process flow may only resume once the comparison module 222, upon receiving new measurements from the measuring device 204, determines that no defects are found on the object 206, i.e. that the defects have been corrected. For this purpose, once it is determined that the defects have been corrected, an output signal may be sent to the machine 208 for causing the latter to resume the machining process. As discussed above, the output signal may also be sent to the devices 210 for rendering thereon.

If no defect is detected, the output signal may indicate so and manufacturing of the object may continue as planned. The output signal may further comprise instructions for the measuring device 204 to acquire additional measurements of the object 206. In particular and as will be discussed further below, the output signal may comprise instructions to move the measuring device 204 towards a different area or surface of the object 206 for acquiring the additional measurements. The output signal may also or alternatively comprise instructions for moving, e.g. rotating, the machine 208 to a desired position for exposing the different area or surface of the object 206. In this manner, the measuring device 204 may acquire the additional measurements.

It should be understood that, in order to adjust operation of the machine 208, instructions to this effect may be incorporated into the output signal generated by the output module 230 and sent directly to the machine 208. Alternatively, the output module 230 may send the machine 208 a software program, which, when executed by the machine 208, results in a modification of an operation of the machine 208.

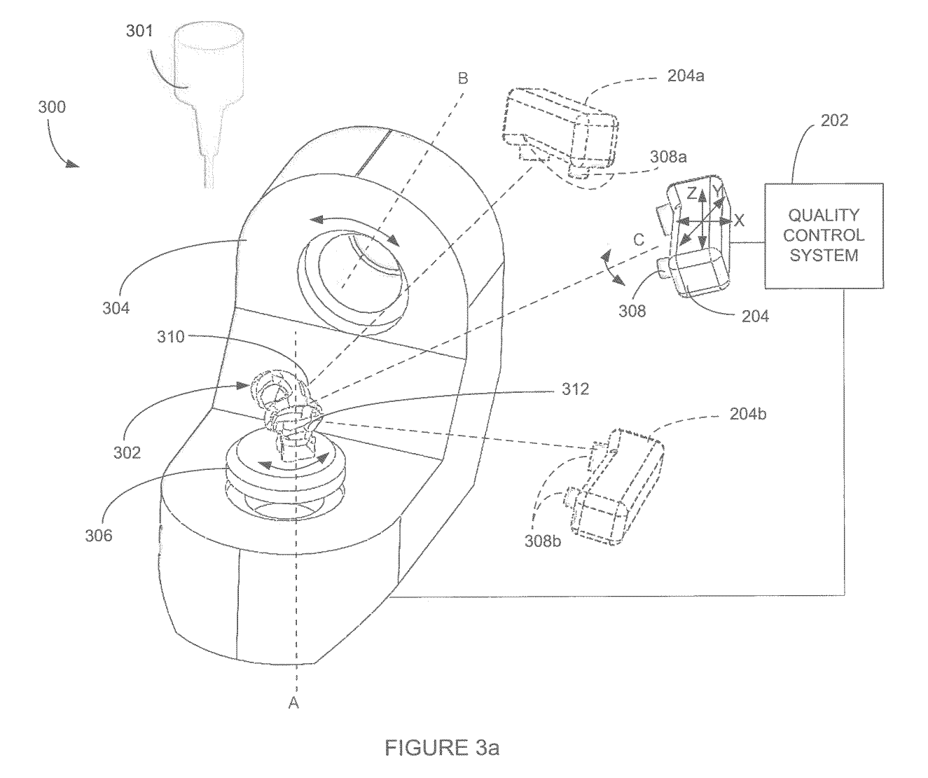

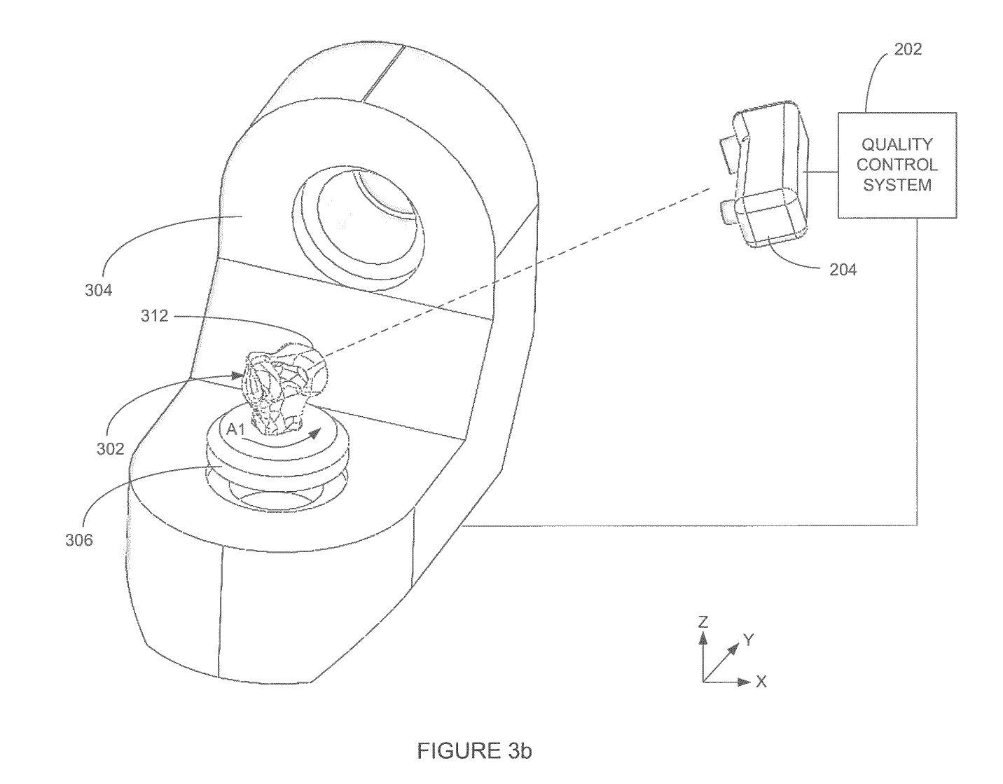

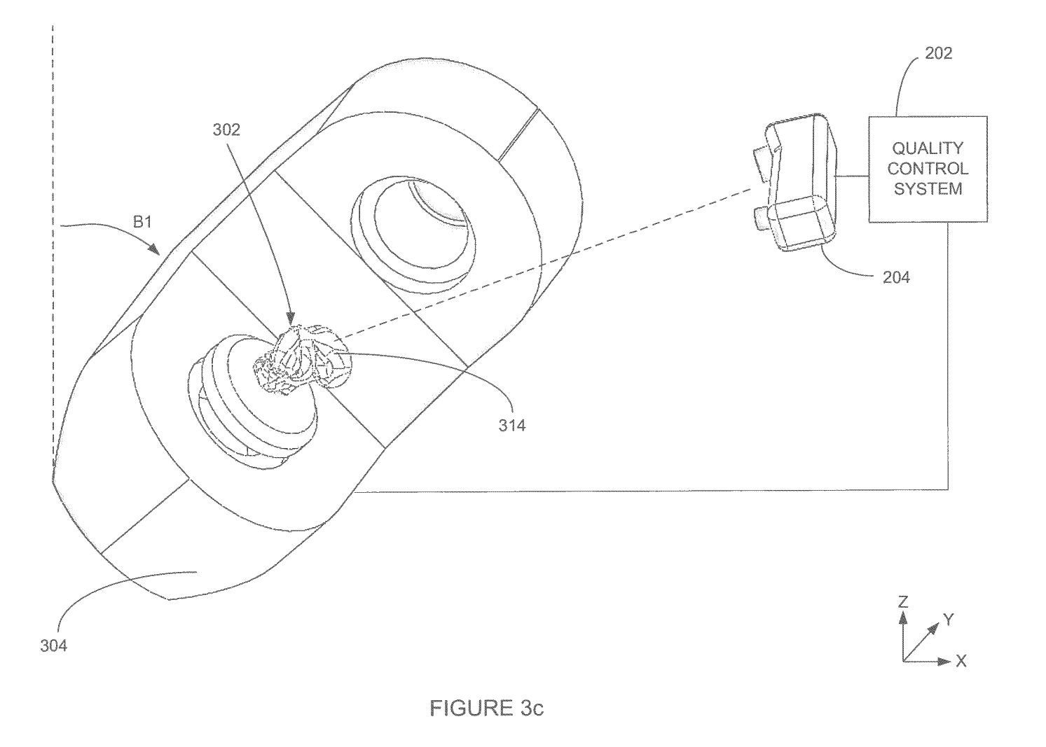

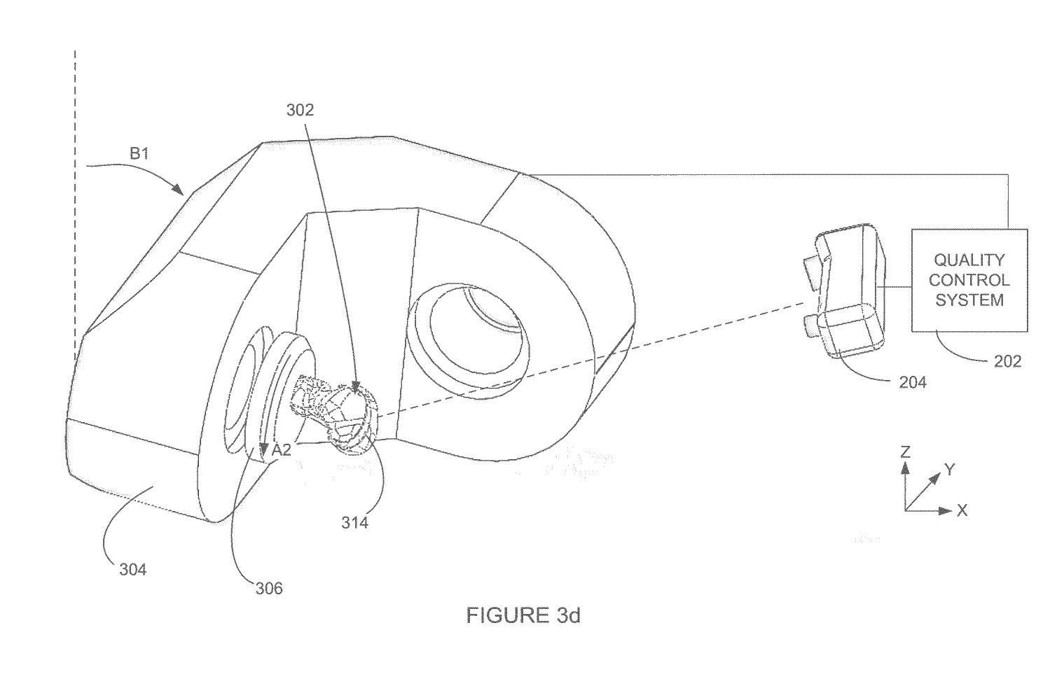

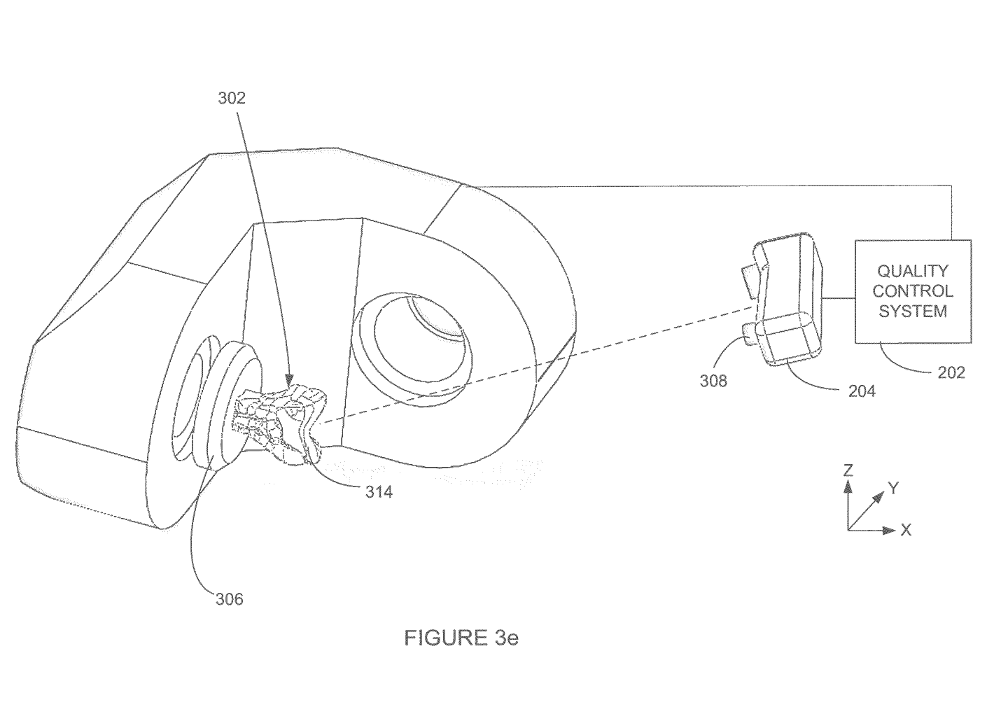

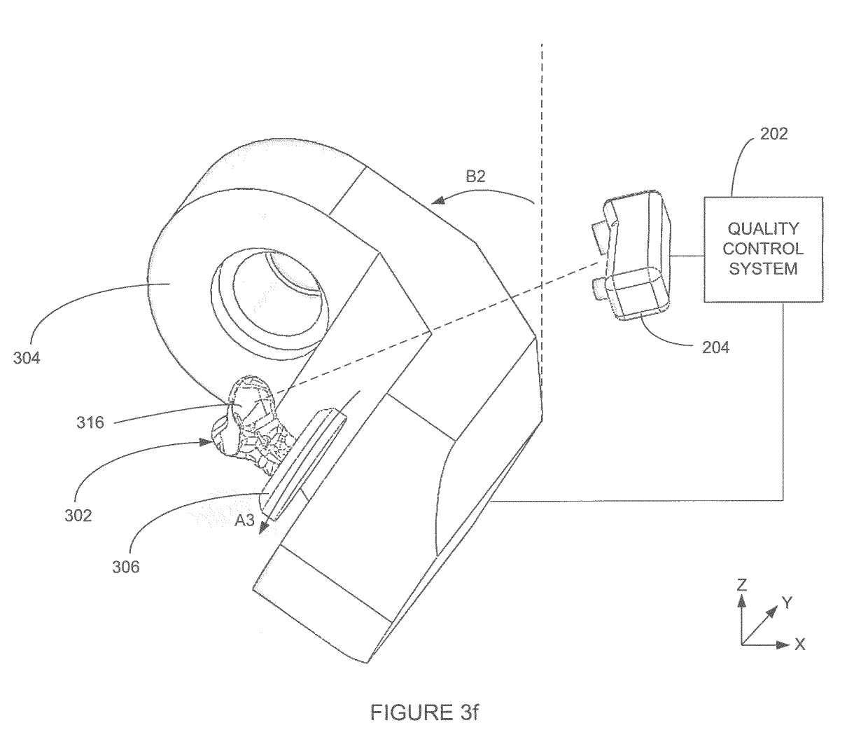

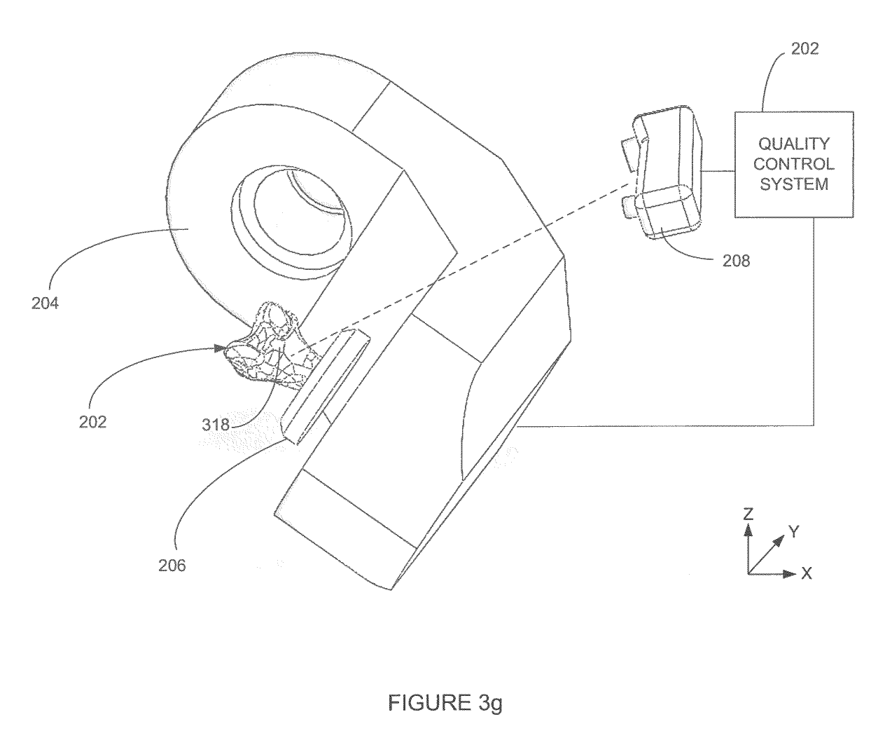

Referring now to FIG. 3a, in one embodiment, the machine 208 is a milling machine 300, such as a CNC-type milling machine, having a cutting tool 301 coupled to a frame (not shown) thereof. The quality control system 202 and the measuring device 204 may be used together with the milling machine 300 to control the quality of an object 206, such as a femoral prosthesis 302, during machining thereof. The milling machine 300 may indeed be used for the creation and machining of the prosthesis 302 from a raw workpiece material (not shown). Although the description below refers to a femoral prosthesis as in 302, it should be understood that other types of prostheses may apply. Also, as discussed above, the method 100 and system 200 may be used for any type of object 206 other than a prosthesis (e.g. a surgical tool).

The prosthesis 302 may be retained on a support frame 304 of the milling machine 300. In particular, the prosthesis 302 may be positioned on a support member 306 rotatably coupled to the support frame 304. The support frame 304 may be substantially L-shaped (as illustrated) while the support member 306 is substantially planar. In some embodiments, the support frame 304 may be U-shaped (not shown). It should be understood that any other suitable shape may apply. The support member 306 may rotate relative to the support frame 304 up to 360 degrees in a clockwise or counterclockwise direction about a first rotary axis A. The support frame 304 may further be adapted to rotate clockwise or counterclockwise up to 180 degrees about a second rotary axis B. The first and second rotary axes A and B are illustratively transverse. In particular, in the illustrated embodiment, axes A and B are substantially perpendicular. Other configurations may apply.

In one embodiment, rotation about axis B may be performed clockwise or counterclockwise by up to 140 degrees relative to the initial position shown in FIG. 3a. Variants of the range of rotation will be readily understood by those skilled in the art. As will be discussed further below, by rotating the support member 306 about the axis A and/or the support frame 304 about the axis B, different surfaces of the prosthesis 302 may be exposed to the measuring device 204. The motion of the milling machine 300, and in particular of the support frame 304 and the support member 306, may be controlled by the quality control system 202. The quality control system 202 may also control the operation of the cutting tool 301.

As discussed above, the quality control system 202 may for this purpose send an output signal to the milling machine 300 for controlling a movement and/or an operation thereof. For example, when defects are detected, the quality control system 202 may send to the milling machine 300 an output signal indicating that the manufacturing process is to be interrupted and that excess material is to be removed from a defective surface of the prosthesis 302. Upon receiving the output signal, the milling machine 300 may move the support frame 304 and/or support member 306 so as to position the defective surface at a suitable orientation relative to the cutting tool 301. The milling machine 300 may then activate rotation of the cutting tool 301 in order for the excess material to be removed from the defective surface. Once the defect has been corrected, an output signal may sent to the milling machine 300 to cause normal manufacturing flow to resume.

The measuring device 204 may further be coupled to a frame (not shown) of the milling machine 300 and may be adapted to move relative to the frame to gain access to the different surfaces of the prosthesis 302. In particular, the measuring device 204 may be translated along the X, Y, and Z translation axes as well as rotated clockwise or counterclockwise up to 360 degrees about the rotary axes A and B as well as about a rotary axis C, which may be transverse to axes A and B. In one embodiment, the movement of the device 204 is effected using automatic control. The measuring device 204 may further comprise heads 308 adapted to acquire measurements of a surface they are positioned adjacent to.

Movement and/or operation of the measuring device 204 may be controlled by the quality control system 202, as discussed above. For example, when measurements of an exposed surface of the prosthesis 302 are to be obtained, the quality control system 202 may send an output signal to the measuring device 204 comprising instructions to position the heads 308 of the measuring device accurately 204 relative to the exposed surface and to initiate data acquisition. Upon receiving the output signal and following the instructions, the measuring device 204 may move along the A, B, C, X, Y, and/or Z axes towards the indicated position. The measuring device 204 may further activate the heads 308 to initiate acquisition of the measurements.

For example, the measuring device 204 may be rotated counterclockwise by about thirty (30) degrees about the axis B and counterclockwise about thirty (30) degrees about the axis A to reach the position 204a illustrated in dotted lines in FIG. 3a. In this position, the heads 308a of the measuring device 204a may be provided with better access to a rear surface 310 of the prosthesis 302. The measuring device 204 may also be rotated clockwise by about thirty (30) degrees about the axis B and translated along the Y axis to reach the position 204b, in which the heads 308b are provided with better access to a first side surface 312 of the prosthesis 302.

Referring to FIG. 3b in addition to FIG. 3a, in order to ensure that precise measurements are obtained, the movement of at least one of the cutting tool 301, the support frame 304, the support member 306, and the measuring device 204 may be controlled by the quality control system 202. Indeed, moving the support frame 304 and support member 306 may facilitate access of the measuring device 204 to the various surfaces of the prosthesis 302. For instance, when in the position illustrated in full lines in FIG. 3a, the measuring device 204 is able to acquire information about the geometry of the rear surface 310 of the prosthesis 302. Once the measuring device 204 is done acquiring measurements of the rear surface 310 and no defects have been detected or any detected defects have been corrected, the quality control system 202 may instruct the machine 208 to rotate the support member 306 counterclockwise by about ninety (90) degrees about the axis A (in the direction of arrow A1). The quality control system 202 may at the same type instruct the measuring device 204 to remain in its current position, i.e. the position of FIG. 3a. As a result, with the support member 306 rotated, the measuring device 204 may now be provided access to the exposed first side surface 312 of the prosthesis 302 for acquiring new measurements.

Referring to FIG. 3c in addition to FIG. 3b, once measurements of the first side surface 312 have been obtained and no defects have been detected or any detected defects have been corrected, the quality control system 202 may instruct the machine 208 to rotate the support frame 304 clockwise by about forty-five (45) degrees about the axis B (in the direction of arrow B1) relative to the previous position shown in FIG. 3b. Upon the machine 208 executing the instructions, the support frame 304 may be rotated by to reach the desired position, as shown in FIG. 3c. In this manner, the measuring device 204 may be provided access to an exposed upper surface 314 of the prosthesis 302 for acquiring measurements thereof.

If the data received from the measuring device 204 proves imprecise or it is desired to obtain additional data of the same surface 314, it may be possible to position the upper surface 314 at a different angle relative to the measuring device 304. For this purpose and as illustrated in FIG. 3d, the quality control system 202 may instruct the machine 208 to further rotate the support frame 304 clockwise about the B axis (in the direction of arrow B1). For example, the support frame 304 may be rotated by substantially ninety (90) degrees relative to the initial position of FIG. 3a. In this position, the upper surface 314 may be positioned at a different angle relative to the measuring device 204 than when the support frame 304 was in the position illustrated in FIG. 3c. As such, the measuring device 204 may be able to acquire additional measurements of features found on the surface 314, the acquired data being different from the data acquired when the support frame 304 was in the position of FIG. 3c.

Moreover, additional data about the geometry of the surface 314 may be obtained by also rotating the support member 306 in addition to rotating the support frame 304. For this purpose and as illustrated in FIG. 3e, the quality control system 202 may instruct the machine 208 to rotate the support member 306 counterclockwise by substantially ninety (90) degrees about the axis A (as shown by the arrow A2 in FIG. 3d). In this position, the upper surface 314 of the prosthesis 302 may be positioned at a different orientation relative to the heads 308 of the measuring device 204 than when in the position illustrated in FIG. 3d. As such, the heads 308 may acquire additional data of the surface 314 and this data may be used together with the previously acquired data to obtain a more accurate representation of the geometry of the surface 314.

Once measurements of the upper surface 314 have been obtained and no defects have been detected or any detected defects have been corrected, the quality control system 202 may instruct the machine 208 to rotate the support frame 304 counterclockwise about the axis B for providing access to additional surfaces of the prosthesis 302. For example, referring to FIG. 3f, the support frame 304 may be rotated counterclockwise by about 135 degrees (as shown by the arrow B2) relative to the position illustrated in FIG. 3e. In this manner, a second side surface 316 of the prosthesis 302, the second side surface 316 being opposite to the side surface 312 of FIG. 3a, may be exposed to the heads 308 of the measuring device 204. Once data acquisition for the side surface 312 has been completed and quality control effected, the support member 306 may be further rotated clockwise about the axis A (as shown by arrow A3 in FIG. 3f) by about ninety (90) degrees. In this position shown in FIG. 3g, a front surface 318 of the prosthesis 302, the front surface 318 illustratively opposite the rear surface 310 shown in FIG. 3a, may be exposed to the measuring device 204. Since both the support frame 304 and the support member 306 may move relative to the measuring device 204, access to all exposed surfaces of the prosthesis 302 may be achieved, thereby easing the data acquisition process and increasing the accuracy of the quality control process.

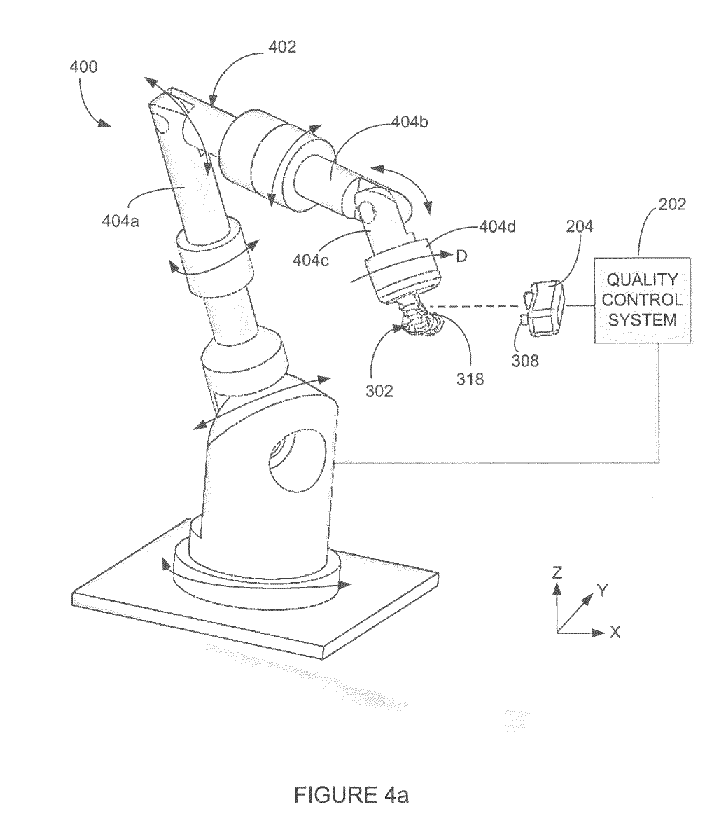

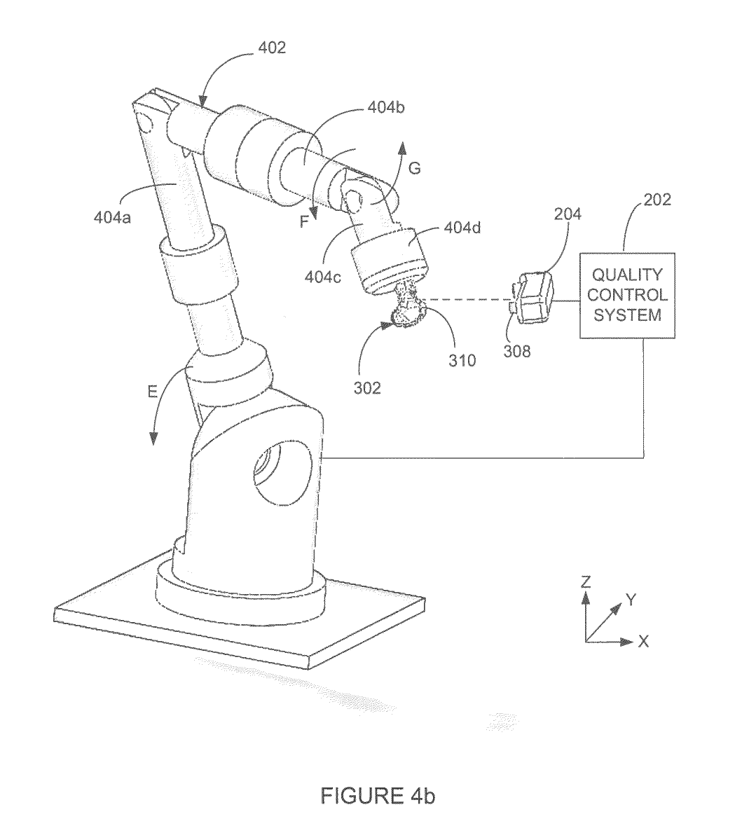

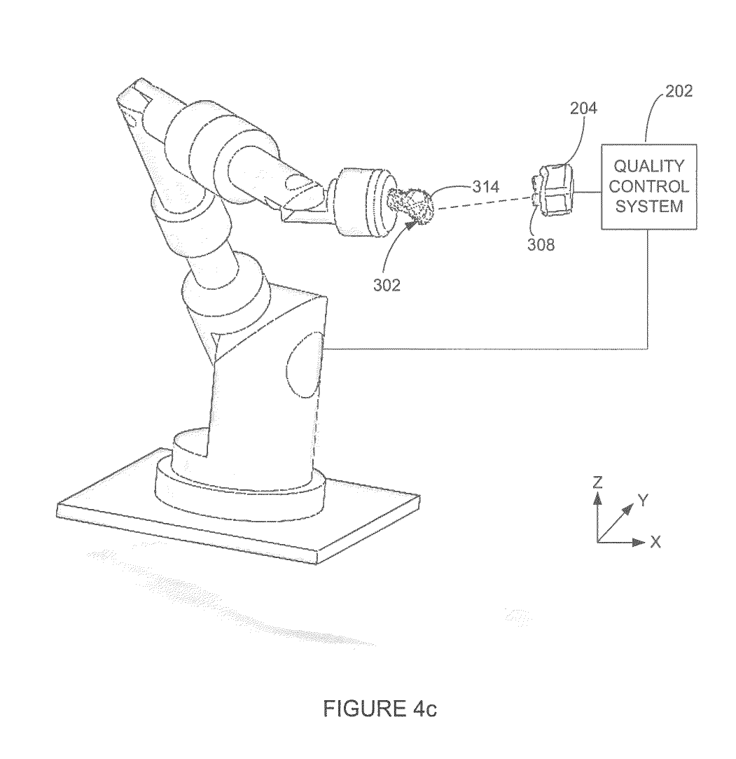

As discussed above, the quality control system 202 may be used during a plurality of manufacturing processes other than machining. For example, in another embodiment illustrated in FIG. 4a, a polishing machine 400 may be used together with the quality control system 202 and the measuring device 204 to control the quality of the prosthesis 302 after machining thereof has been completed. The polishing machine 400 may be used to finish the machined prosthesis 302, e.g. to control a shape and surface friction thereof, and may comprise an articulated arm 402 to which the prosthesis 302 is coupled. The arm 402 may comprise elements as in 404a, 404b, 404c, and 404d, which may rotate independently from one another in the direction of the arrows illustrated in FIG. 4a for articulating the arm 402. Using the articulated arm 402, the prosthesis 302 may then be placed at a desired position relative to the measuring device 204. For example, in the position shown in FIG. 4a, the front surface 318 of the prosthesis 302 is illustratively positioned adjacent the heads 308 of the measuring device 204. In this manner, the measuring device 204 may accurately acquire measurements of the geometry of the front surface 318.

The quality control system 202 may then send an output signal to the polishing machine 400 for instructing the arm element 404d to rotate in the direction of arrow D by about 180 degrees. The position shown in FIG. 4b may thus be achieved. In this position, the rear surface 310 of the prosthesis 302 may be placed adjacent the heads 308 of the measuring device 204. The measurement of features found on the surface 310 may therefore be performed accurately by the measuring device 204. Upon receiving measurements from the measuring device 204 and performing the quality control process discussed above with reference to FIG. 2c, the quality control system 202 may further instruct the polishing machine 400 to move to a different position for obtaining measurements of a different surface of the prosthesis 302. As such, the quality control system 202 may instruct the arm elements 404a, 404b, and 404c to rotate in the direction of arrows E, F, and G, respectively. As a result, the upper surface 314 of the prosthesis 302 may be positioned adjacent the heads 308 of the measuring device 204, as illustrated in FIG. 4c. Although not illustrated, it should be understood that the quality control system 202 may also instruct the measuring device 204 to rotate and/or translate, as discussed above, relative to the polishing machine 400 to further accurately position the heads 308 of the measuring device 204 in a desired position relative to the surfaces of the prosthesis 302.

It should also be understood that, in the embodiments described above with reference to FIG. 3a to FIG. 4c, various positions other than the illustrated positions may be achieved. Moreover, the sequence of such positions may vary. It should be further understood, as discussed above, that defect detection may be performed once all measurements of the prosthesis 302 have been obtained rather than after each new measurement is acquired.

While illustrated in the block diagrams as groups of discrete components communicating with each other via distinct data signal connections, it will be understood by those skilled in the art that the present embodiments are provided by a combination of hardware and software components, with some components being implemented by a given function or operation of a hardware or software system, and many of the data paths illustrated being implemented by data communication within a computer application or operating system. The structure illustrated is thus provided for efficiency of teaching the present embodiment. It should be noted that the present invention can be carried out as a method, can be embodied in a system, and/or on a computer readable medium. The embodiments of the invention described above are intended to be exemplary only. The scope of the invention is therefore intended to be limited solely by the scope of the appended claims.

1. A system for controlling a quality of an object during machining thereof with a machine, the system comprising:
a memory;
a processor; and
at least one application stored in the memory and executable by the processor for
receiving during the machining measurement data from a measuring device, the measurement data comprising at least one measurement of the object,
determining from the received measurement data whether the object comprises a defect, and
generating a first output signal for causing the machine to correct a detected defect.

2. The system of claim 1, wherein the at least one application is executable by the processor for generating the first output signal comprising instructions for causing an interruption in the machining, causing the machine to correct the detected defect during the interruption, and causing the machining to resume once correction of the detected defect has been completed.

3. The system of claim 2, wherein the at least one application is executable by the processor for generating the first output signal comprising instructions for causing the machine to perform at least one corrective action for correcting the detected defect, the at least one corrective action comprising at least one of removing material from, adding material to, and modifying a shape of a surface of the object where the detected defect is present.

4. The system of claim 2, wherein the memory has stored therein a plurality of corrective actions each associated with a corresponding one of a plurality of likely defects of the object and adapted to be performed by the machine for correcting the corresponding one of the plurality of likely defects, the detected defect among the plurality of likely defects, and wherein the at least one application is executable by the processor for retrieving from the memory a selected one of the plurality of corrective actions associated with the detected defect and for generating the first output signal comprising instructions for causing the machine to perform the selected one of the plurality of corrective actions.

5. The system of claim 2, wherein the at least one application is executable by the processor for computing a path to be followed by the machine to correct the detected defect and for generating the first output signal comprising instructions for causing the machine to be operated during the interruption in accordance with the computed path.

6. The system of claim 1, wherein the at least one application is executable by the processor for receiving the measurement data comprising:
(a) receiving during the machining a current set of measurements of the object from the measuring device,
(b) determining from the current set of measurements whether additional measurements are to be acquired,
(c) if the additional measurements are to be acquired, generating a second output signal for modifying a relative position of the measuring device with respect to the object as machining of the object continues and for causing the measuring device to acquire a new set of measurements during the machining,
(d) receiving the new set of measurements from the measuring device during the machining and setting the new set as the current set, and
(e) repeating steps (b) to (d) until no additional measurements are to be acquired.

7. The system of claim 6, wherein the at least one application is executable by the processor for determining whether the additional measurements are to be acquired comprising determining whether the current set of measurements comprises measurements acquired for all surfaces of the object.

8. The system of claim 6, wherein the at least one application is executable by the processor for determining whether the object comprises a defect prior to determining from the current set of measurements whether the additional measurements are to be acquired.

9. The system of claim 6, wherein the at least one application is executable by the processor for generating the second output signal for modifying the relative position of the measuring device with respect to the object comprising generating the second output signal comprising instructions for causing at least one of translation about one or more translation axes and rotation about one or more rotation axes of at least one of the measuring device and the object.

10. The system of claim 1, wherein the memory has stored therein predetermined measurement data for the object and the at least one application is executable by the processor for determining from the received measurement data whether the object comprises the defect comprising retrieving the predetermined measurement data from the memory, computing a difference between the predetermined measurement data and the received measurement data, comparing the difference to a predetermined threshold, and detecting the defect if the difference exceeds the threshold.

11. The system of claim 1, wherein the memory has stored therein predetermined measurement data comprising a desired surface geometry for the object and wherein the at least one application is executable by the processor for receiving the measurement data comprising measurements intermittently acquired by the measuring device at a plurality of points on a surface of the object and reconstructing a surface geometry of the object from the acquired measurements, and for determining whether the object comprises the defect comprising retrieving the desired surface geometry from the memory, comparing the desired surface geometry to the reconstructed surface geometry, and detecting the defect if at least one discrepancy is found between the desired surface geometry and the reconstructed surface geometry.

12. A computer-implemented method for controlling a quality of an object during machining thereof with a machine, the method comprising:
receiving during the machining measurement data from a measuring device, the measurement data comprising at least one measurement of the object;
determining from the received measurement data whether the object comprises a defect; and
generating a first output signal for causing the machine to correct a detected defect.

13. The method of claim 12, wherein the first output signal is generated as comprising instructions for causing an interruption in the machining, causing the machine to correct the detected defect during the interruption, and causing the machining to resume once correction of the detected defect has been completed.

14. The method of claim 13, further comprising retrieving from a memory a selected one of a plurality of corrective actions associated with the detected defect, the memory having stored therein the plurality of corrective actions each associated with a corresponding one of a plurality of likely defects of the object and adapted to be performed by the machine for correcting the corresponding one of the plurality of likely defects, the detected defect among the plurality of likely defects, and wherein the first output signal is generated as comprising instructions for causing the machine to perform the selected one of the plurality of corrective actions.

15. The method of claim 13, further comprising computing a path to be followed by the machine to correct the detected defect and wherein the first output signal is generated as comprising instructions for causing the machine to be operated during the interruption in accordance with the computed path.

16. The method of claim 12, wherein receiving the measurement data comprises:
(a) receiving during the machining a current set of measurements of the object from the measuring device,
(b) determining from the current set of measurements whether additional measurements are to be acquired,
(c) if the additional measurements are to be acquired, generating a second output signal for modifying a relative position of the measuring device with respect to the object as machining of the object continues and for causing the measuring device to acquire a new set of measurements during the machining,
(d) receiving the new set of measurements from the measuring device during the machining and setting the new set as the current set, and
(e) repeating steps (b) to (d) until no additional measurements are to be acquired.

17. The method of claim 16, wherein determining whether the additional measurements are to be acquired comprises determining whether the current set of measurements comprises measurements acquired for all surfaces of the object.

18. The method of claim 16, wherein determining whether the object comprises a defect is performed prior to determining from the current set of measurements whether the additional measurements are to be acquired.

19. The method of claim 16, wherein generating the second output signal for modifying the relative position of the measuring device with respect to the object comprises generating the second output signal comprising instructions for causing at least one of translation about one or more translation axes and rotation about one or more rotation axes of at least one of the measuring device and the object.

20. The method of claim 12, wherein the memory has stored therein predetermined measurement data for the object and determining from the received measurement data whether the object comprises the defect comprises retrieving the predetermined measurement data from the memory, computing a difference between the predetermined measurement data and the received measurement data, comparing the difference to a predetermined threshold, and detecting the defect if the difference exceeds the threshold.

21. The method of claim 12, wherein the memory has stored therein predetermined measurement data comprising a desired surface geometry for the object and wherein the received measurement data comprises measurements intermittently acquired by the measuring device at a plurality of points on a surface of the object, the method further comprising reconstructing a surface geometry of the object from the acquired measurements, and wherein determining whether the object comprises the defect comprises retrieving the desired surface geometry from the memory, comparing the desired surface geometry to the reconstructed surface geometry, and detecting the defect if at least one discrepancy is found between the desired surface geometry and the reconstructed surface geometry.

22. A computer readable medium having stored thereon program code executable by a processor for controlling a quality of an object during machining thereof with a machine, the program code executable for:
receiving during the machining measurement data from a measuring device, the measurement data comprising at least one measurement of the object;
determining from the received measurement data whether the object comprises a defect; and
generating a first output signal for causing the machine to correct a detected defect.
